(19) United States
(12) Patent Application Publication
(10) Pub. No.: US 2011/0085847 A1
(43) Pub. Date: Apr. 14, 2011

(54) JOINT STRUCTURE FOR A COLLAPSIBLE PLAY YARD

(75) Inventor: Luke Anderson, Guang Dong Province (CN)

(73) Assignee: LERADO (ZHONG SHAN) INDUSTRIAL CO., LTD, Zhong Shan City (CN)

(21) Appl. No.: 12/902,925

(22) Filed: Oct. 12, 2010

(30) Foreign Application Priority Data
Oct. 13, 2009 (CN) 200920179638.0

(51) Int. Cl. F16B 7/00

(52) U.S. Cl. 403/81

(57) ABSTRACT

A joint structure for a collapsible play yard, includes a U-shaped housing, a button-mount, a sliding block and a button. The U-shaped housing has a pair of side walls for pivoting with a pair of frame bar members each having a length of substantially flattened undersurface. The button-mount is formed with a sliding way, attached to one of the side walls. The sliding block is movable transversally engaging with the substantially flattened undersurface of both of the frame bar members in an engaged position, and movable to a released position to release both of the frame bar members for folding the collapsible play yard. The button connects with the sliding block and is biased by a resilient element for reciprocally sliding along the sliding way so as to drive the sliding block to the engaged position and the released position.

### CROSS-REFERENCE TO RELATED APPLICATIONS

This non-provisional application claims priority under 35 U.S.C. §119(a) on Patent Application No(s). 200920179638.0 filed in China on Oct. 13, 2010, the entire contents of which are hereby incorporated by reference.

### FIELD OF THE INVENTION

The present invention relates to a joint structure, and in particular, to a joint structure which is manipulated by pushing a button for folding a collapsible play yard.

### DESCRIPTION OF THE RELATED ART

Generally, play yard for keeping and caring infants or pets inside is designed for easy portable and stow, such as the play yard in U.S. Pat. No. 4,811,437 issued to Dillner disclosed a play yard with a structure having a bed frame covered by fabrics and a space formed for accommodating infants or pets.

For convenience to carry and to store the play yard, generally it is designed to be deployable and collapsible. The foldable play yard is provided with a joint for deploying the frame stably and collapsing conveniently. For instance, U.S. Pat. No. 6,250,837 to Mariol disclosed a play yard which having a structure for making use of the ends of a pair of arms to engage with the locking members which is connected to the ends of upper rails of both sides, therefore, the upper rails are fixed and the frame is in a stable deployed status. Whenever the user intends to fold the frame, a rotational member is used to drive the pair of arms to disengage the end of the arms from the locking members for further rotating of the upper rails to convert into in a folded status.

Since the locking member of the joint structure of the prior art is troublesomely connected to the ends of the upper rails, a gap is then to be caused and thus would result in a wobbling problem of the joint structure; therefore an unsuccessful locking may be resulted for having the gap. Moreover, such an unsuccessful locking may be also caused by the weakness of the arms of the locking member which is merely been supported by ends of the arms.

### SUMMARY OF THE INVENTION

In order to simplify the manipulation and structure of the related art, the present invention provides a joint structure for a collapsible play yard, includes a U-shaped housing, a button-mount, a sliding block and a button. The U-shaped housing has a pair of side walls for pivoting with a pair of frame bar members each having a length of substantially flattened undersurface. The button-mount is formed with a sliding way and attached to one of the side walls. The sliding block is movable transversally engaging with the substantially flattened undersurface of both of the frame bar members in an engaged position, and movable to a released position to release both of the frame bar members for folding the collapsible play yard. The button connects with the sliding block and is biased by a resilient element for reciprocally sliding along the sliding way so as to drive the sliding block to the engaged position and the released position. When pushing on the button, the sliding block can be driven to the released position that permits the pair of frame bar members to be rotatable relative to the U-shaped housing.

### BRIEF DESCRIPTION OF THE DRAWINGS

The present invention will become more fully understood from the detailed description given hereinbelow and the accompanying drawings, which are given by way of illustration only, and thus are not limitative of the present invention.

FIG. 1 illustrates a schematic front view of a frame of collapsible play yard with a pair of frame bar members and the joint structure of the present invention.

FIG. 2 is an exploded view of an embodiment of the joint structure according to the present invention.

FIG. 3 is a schematic cross-sectional side view showing the joint structure according to the present invention.

FIG. 4 is a schematic cross-sectional side view showing the joint structure in an unfoldable status, wherein the sliding block being engaged with the substantially flattened undersurface of both of the frame bar members.

FIG. 5 is another schematic cross-sectional side view showing the joint structure in an unfoldable status, wherein the sliding block being engaged with the substantially flattened undersurface of both of the frame bar members.

FIG. 6 is another schematic cross-sectional side view showing the joint structure in a foldable state, wherein the sliding block being disengaged from the substantially flattened undersurface of both of the frame bar members.

FIG. 7 is a schematic view showing the frame bar members are permitted to rotate relative to the joint structure while the sliding block being disengaged from the substantially flattened undersurface of both of the frame bar members by pushing the button inwardly.

FIG. 8 is a schematic view showing the frame of collapsible play yard being folded into a folded status.

FIG. 9 is a side view of an embodiment that an indicating element is arranged for indicating the sliding block as being engaged with the substantially flattened undersurface of both of the frame bar members.

### DETAILED DESCRIPTION OF THE PREFERRED EMBODIMENTS

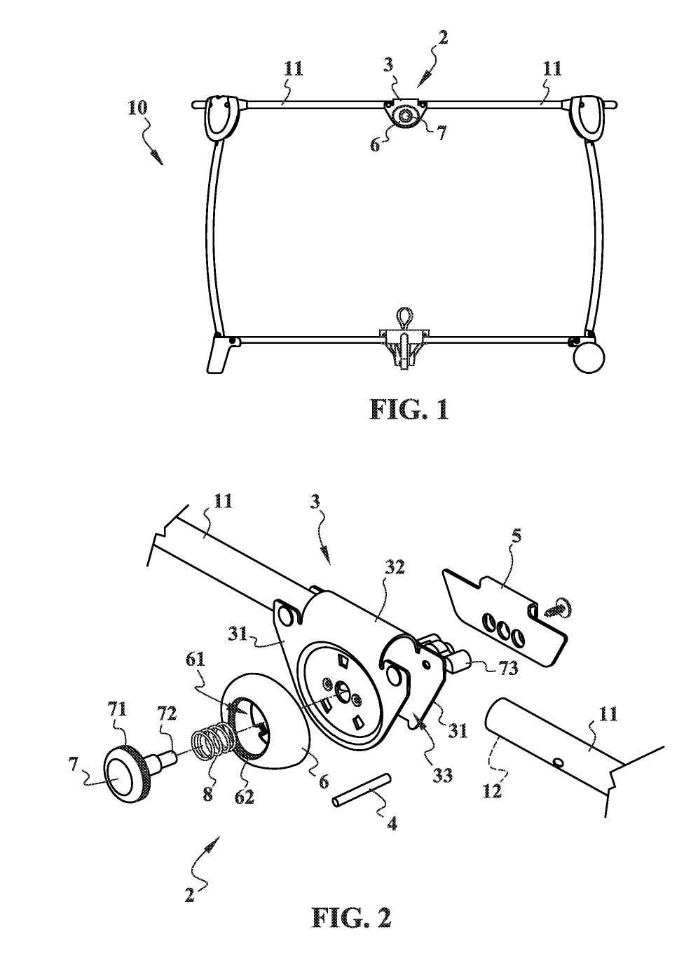

Preferred embodiments of the apparatus according to the present invention will now be described in detail with reference to the drawings. FIGS. 1 and 4 illustrate a frame 10 of a collapsible play yard with a pair of frame bar members 11 and the joint 3 of the present invention.

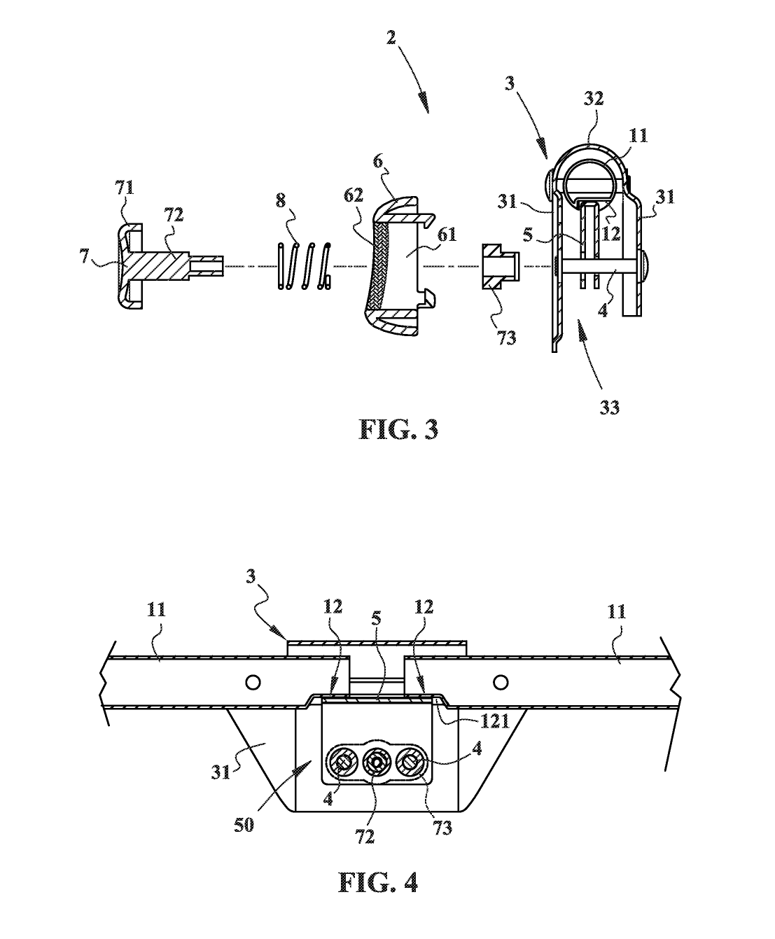

Referring to FIGS. 2 to 3, an embodiment of the joint structure 2 according to the present invention, includes a U-shaped housing 3, a button-mount 6, a sliding block 5 and a button 7. The U-shaped housing 3 has an inner space 33 covered with a pair of side walls 31 and a transversal connecting wall 32. The pair of side walls pivot with a pair of frame bar members 11, each has a length of substantially flattened undersurface 12. Preferably, an indent 121 may be formed on the substantially flattened undersurface 12 for getting a better engagement with the sliding block 5, as illustrated in FIG. 4.

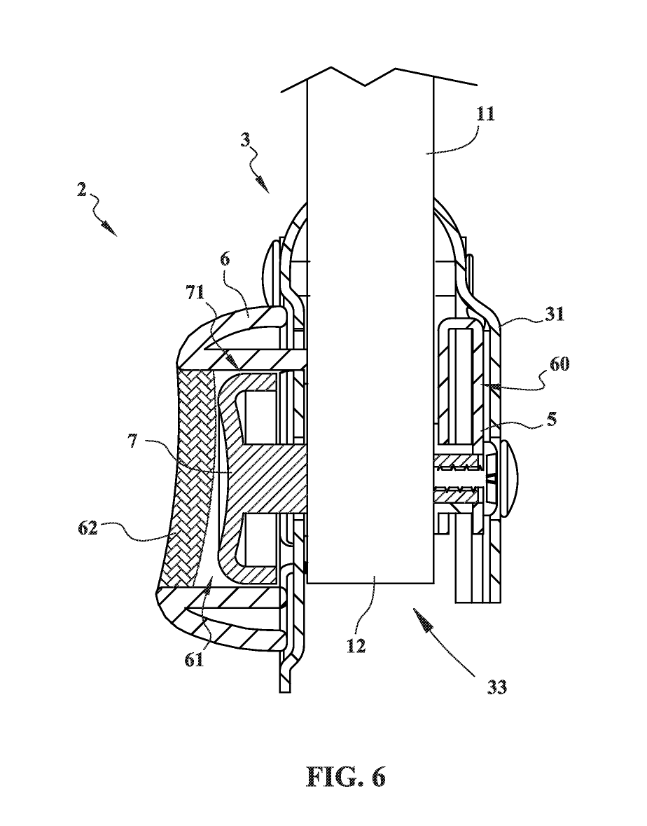

The button-mount 6 is attached to one of the side walls 31 and formed with a sliding way 61 for guiding the button 7 sliding therein reciprocally. Preferably, the sliding way 61 may be covered with a first colored surface 62 which reveals while the button 7 is pushed inwardly and the sliding block 5 is disengaged from both of the frame bar members 11 as shown in FIG. 6.

The sliding block 5 is movable transversally to engage with the substantially flattened undersurface 12 in an engaged position 50, and movable to a released position 60 to release both of the frame bar members 11 for folding the frame 10 of collapsible play yard.

The button 7 connects with the sliding block 5 and is biased by a resilient element 8 for reciprocally sliding along the sliding way 61 so as to drive the sliding block 5 to the engaged position 50 and the released position 60.

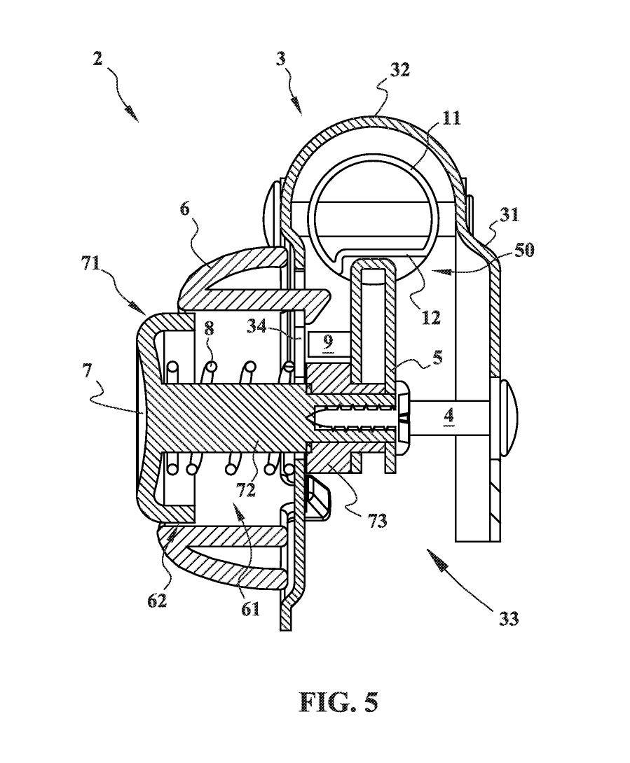

The resilient element 8 may be embodied as a compression spring which sleeves on the stem 72, with one end biasing on one of the side walls 31, and another end biasing on the button 7, exerting to force the sliding block 5 to move toward the engaged position 50 as best shown in FIG. 5.

Referring to FIGS. 2, 4 and 5, a pair of transversal guiding rails 4 is fixed between the pair of side walls 31. A slidable connector 73 is formed with a pair of holes that sleeves on the transversal guiding rails 4 for guiding the sliding block 5. Further, the slidable connector 73 may be formed with a hole sleeved on the stem 72 and fastened by a screw at the end portion so as to be sandwiched between the button 7 and the sliding block 5.

Preferably, the button 7 has a second colored surface 71 covered on the circumference that reveals while the sliding block 5 is moved into the engaged position 50, and invisible while the sliding block 5 is moved into the released position 60.

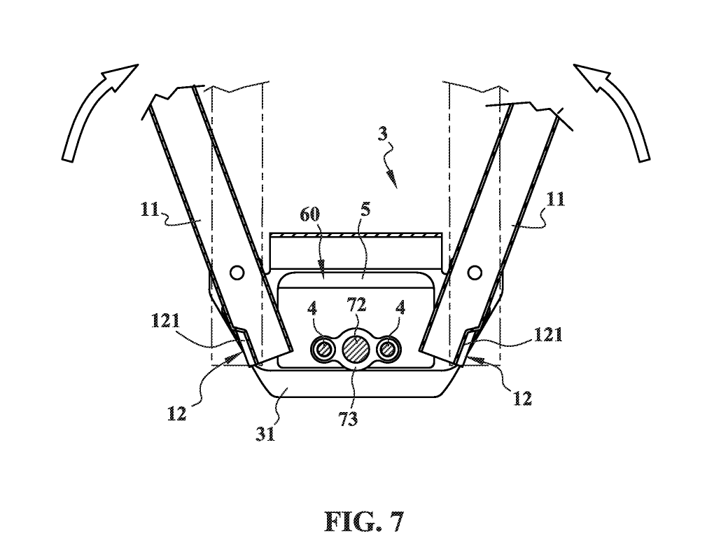

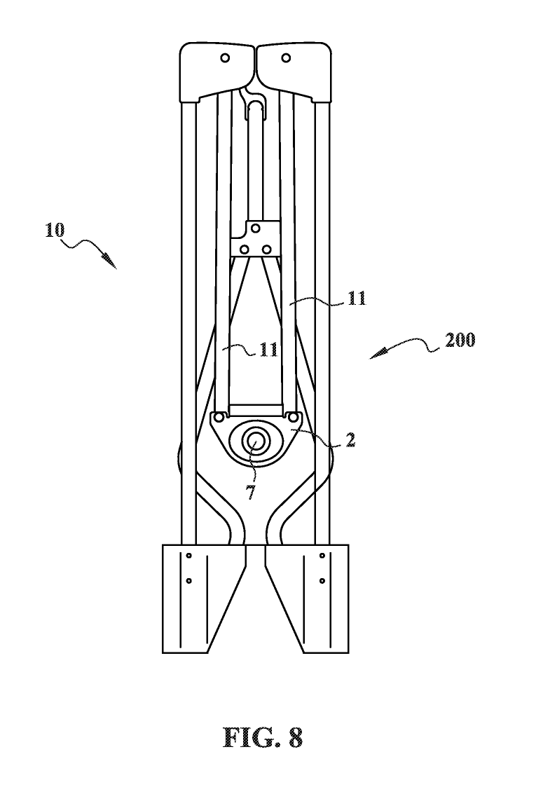

As schematically illustrated in FIGS. 6 to 7, when pushing the button 7, the sliding block 5 is moved to the released position 60, would permit the pair of frame bar members to rotate relative to the u-shaped housing 3, and ultimately to be folded in a folded state 200 as illustrated in FIG. 8.

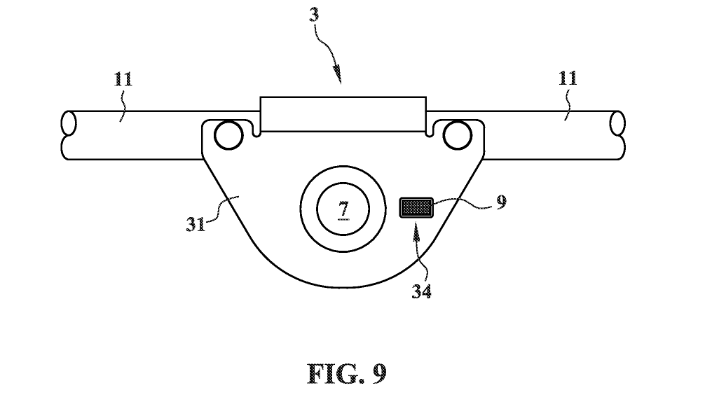

Referring to FIGS. 5 and 9, one of the side walls 31 may be formed with a window 34 or an opening (not shown) for indicating the sliding block 5 is moved to the engaged position 50. Preferably, an indicating element with a colored surface is attached on the sliding block 5 for showing in the window 34, while the sliding block 5 is moved into the engaged position 50.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A joint structure for a collapsible play yard, including:
a U-shaped housing, having a pair of side walls for pivoting with a pair of frame bar members each having a length of substantially flattened undersurface,
a button-mount formed with a sliding way, attached to one of the side walls;
a sliding block, movable transversally to engage with the substantially flattened undersurface of both of the frame bar members in an engaged position, and movable to a released position to release both of the frame bar members for folding the collapsible play yard; and
a button, connected with the sliding block and biased by a resilient element for reciprocally sliding along the sliding way so as to drive the sliding block to the engaged position and the released position.

2. The joint structure for a collapsible play yard of claim 1, wherein the sliding way having a first colored surface for indicating that the sliding block being moved to a released position, and both of the frame bar members are permitted to rotate relative to the U-shaped housing.

3. The joint structure for a collapsible play yard of claim 1, wherein the resilient element has one end biasing on one of the side walls, and another end biasing on the button, thereby to force the sliding block moving toward the engaged position.

4. The joint structure for a collapsible play yard of claim 1, wherein each of the substantially flattened undersurface of both of the frame bar members is formed with a an indent for engaging with the sliding block.

5. The joint structure for a collapsible play yard of claim 1, wherein one of the side walls is formed with a window for indicating the sliding block is moved to the engaged position.

6. The joint structure for a collapsible play yard of claim 1, wherein the button has a second colored surface, which is revealed when the sliding block is moved to the engaged position.

7. The joint structure for a collapsible play yard of claim 1, wherein the button has a second colored surface, which is hidden when the sliding block is moved to the released position.

8. The joint structure for a collapsible play yard of claim 1, wherein the sliding block is guided by a pair of transversal guiding rails both of which are connected between the pair of side walls.

9. The joint structure for a collapsible play yard of claim 1, wherein the button has a stem for connecting the sliding block at the end portion thereof.

10. The joint structure for a collapsible play yard of claim 1, wherein one of the side walls is formed with a window for revealing an indicating element, when the sliding block is moved to the engaged position.

11. The joint structure for a collapsible play yard of claim 10, wherein the indicating element is attached on the sliding block and has a colored surface for show in the window.

12. The joint structure for a collapsible play yard of claim 10, wherein the window is an opening formed on the U-shaped housing.
